(19) United States
(12) Patent Application Publication
(10) Pub. No.: US 2024/0255540 A1
(43) Pub. Date: Aug. 1, 2024

(54) POSITION DETECTION DEVICE

(71) Applicant: Proterial, Ltd., Tokyo (JP)

(72) Inventors: Yohei SHIRAKAWA, Tokyo (JP); Yoshiaki YANAGISAWA, Tokyo (JP); Yoshitake AGEISHI, Tokyo (JP); Yujiro TOMITA, Tokyo (JP)

(21) Appl. No.: 18/419,345

(22) Filed: Jan. 22, 2024

(30) Foreign Application Priority Data
Jan. 27, 2023 (JP) 2023-010652

(51) Int. Cl. G01P 3/50; B62D 3/12; G01D 5/20

(52) U.S. Cl. CPC G01P 3/505; B62D 3/12; G01D 5/2053

(57) ABSTRACT

A position detection device for detecting a position of a moving member moving forward and backward in a predetermined moving direction is provided with a detection object attached to the moving member, a substrate provided with an excitation coil being positioned to face the moving member and parallel to the moving direction of the moving member for generating a magnetic field in an area including the detection object, and a detection coil being interlinked with a magnetic flux of the magnetic field, a power supply unit for supplying an alternating current to the excitation coil, a calculation unit that calculates the position of the moving member based on an output voltage of the detection coil, and a spacing fluctuation suppression structure that suppresses fluctuations in a spacing between a facing surface facing the detection object and the detection object in the substrate.

### CROSS-REFERENCE TO RELATED APPLICATIONS

The present patent application claims the priority of Japanese patent application No. 2023-010652 filed on Jan. 27, 2023, and the entire contents thereof are hereby incorporated by reference.

### TECHNICAL FIELD

The present invention relates to a position detection device that detects the position of a moving member that moves forward and backward in a predetermined direction.

### BACKGROUND OF THE INVENTION

Conventionally, a position detection device that detects the position of a shaft that moves forward and backward (i.e., reciprocating) in the axial direction is being used, for example, to detect the position of a rack shaft in a steering device of a vehicle.

A detection unit described in Patent Literature 1 detects an axial position of a rack shaft of an electric power steering device and includes a DC power source, a permanent magnet, an element group composed of first to fourth magnetoresistive elements disposed between the permanent magnet and the rack shaft, and a calculation unit for calculating the position of the rack shaft. In the element group, a series circuit including the first and second magnetoresistive elements being connected in series, and a series circuit including the third and fourth magnetoresistive elements being connected in series are connected in parallel to form a bridge circuit. To the calculation unit, a potential of a first terminal connected between the first magnetoresistive element and the second magnetoresistive element and a potential of a terminal connected between the third magnetoresistive element and the fourth magnetoresistive element are input. Plural grooves extending in a direction inclined with respect to the axial direction of the rack shaft are formed on the surface of the rack shaft facing the element group.

In the detection unit configured as described above, when the rack shaft moves in the axial direction due to the rotation of the pinion gear shaft meshing with the rack shaft and the relative positions of the first to fourth magnetoresistive elements with respect to the grooves change, the electric resistance balance of the first to fourth magnetoresistive elements changes, so that the potentials of the first terminal and the second terminal change. The calculation unit calculates the position of the rack shaft based on changes in these potentials.

Citation List Patent Literature 1: WO2021/210125

### SUMMARY OF THE INVENTION

In the detection unit disclosed in Patent Literature 1, for example, when the rack shaft moves in a vertical direction (i.e., upward and downward) due to vibrations or the like caused by the running of the vehicle, the position of the first to fourth magnetoresistive elements relative to the grooves changes, and an error will occur in the detected position of the rack shaft. Further, if the rack shaft is mounted eccentrically, the distance between the first to fourth magnetoresistive elements and the plurality of grooves on the rack shaft changes, thereby causing an error in the detection position of the rack shaft.

Accordingly, it is an object of the present invention to provide a position detection device capable of suppressing the deterioration in position detection accuracy even when vibration occurs in a moving member of a position detection object (target) or when the moving member is mounted eccentrically.

To solve the problems mentioned above, the present invention provides: a position detection device for detecting a position of a moving member moving forward and backward in a predetermined moving direction, comprising:
a detection object attached to the moving member;
a substrate provided with an excitation coil being positioned to face the moving member and parallel to the moving direction of the moving member for generating a magnetic field in an area including the detection object, and a detection coil being interlinked with a magnetic flux of the magnetic field;
a power supply unit for supplying an alternating current to the excitation coil;
a calculation unit that calculates the position of the moving member based on an output voltage of the detection coil; and
a spacing fluctuation suppression structure that suppresses fluctuations in a spacing between a facing surface facing the detection object and the detection object in the substrate.

### Effects of the Invention

According to the position detection device according to the present invention, it is possible to suppress the deterioration in position detection accuracy even when vibration occurs in a moving member of a position detection object (target) or when the moving member is mounted eccentrically.

### BRIEF DESCRIPTION OF DRAWINGS

FIG. 1 is a schematic diagram of a vehicle equipped with a steer-by-wire steering device having a stroke sensor as a position detection device, according to the first embodiment of the present invention.

FIG. 2 is a cross-sectional view of a rack shaft, a housing, a target, and a substrate taken along line A-A of FIG. 1.

FIG. 3 is a perspective view showing the rack shaft, a main body of the housing, the target, and the substrate.

FIG. 4A is an overall view of wiring patterns formed on the first to fourth metal layers of the substrate seen through from a front surface side.

FIG. 4B is a partially enlarged view of FIG. 4A.

FIGS. 5A to 5D are plan views, respectively showing the first to fourth metal layers viewed from the front surface side.

FIG. 6 is a graph showing the relationship between a supply voltage supplied from a power supply unit to an excitation coil, an induced voltage induced in the sine wave-shaped detection coil, and an induced voltage induced in a cosine wave-shaped detection coil.

FIG. 7 is an explanatory diagram schematically showing the relationship between a peak voltage, which is a peak value of the induced voltage induced in the sine wave-shaped detection coil, and the position of the target.

FIG. 8 is an explanatory diagram schematically showing the relationship between a peak voltage, which is a peak value of the induced voltage induced in the cosine wave-shaped detection coil, and the position of the target.

FIG. 9 is a cross-sectional view of a rack shaft and its peripheral parts according to a modified example 1 of the first embodiment.

FIG. 10 is a perspective view of a portion of the rack shaft according to the modified example 1 of the first embodiment, viewed from diagonally above.

FIG. 11 is a configuration diagram of a rack shaft according to a modified example 2 of the first embodiment, viewed from above in the vertical direction.

FIG. 12 is a perspective view of a portion of a rack shaft according to the modified example 2 of the first embodiment, viewed from diagonally above.

FIG. 13 is a cross-sectional view of the rack shaft and its peripheral parts according to the modified example 2 of the first embodiment.

FIG. 14 is a cross-sectional view of the rack shaft and its peripheral parts according to the modified example 2 of the first embodiment.

FIG. 15 is a cross-sectional view of the rack shaft and its peripheral parts according to the modified example 2 of the first embodiment in a cross-section perpendicular to the axial direction of the rack shaft.

FIG. 16 is a cross-sectional view taken along line B-B of FIG. 15.

### DETAILED DESCRIPTION OF THE INVENTION

### Embodiments

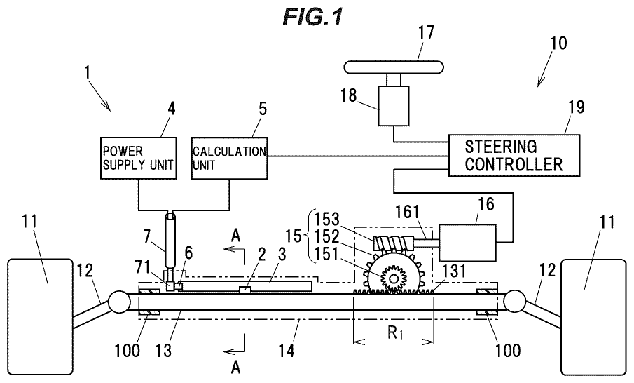

FIG. 1 is a schematic diagram of a vehicle equipped with a steer-by-wire steering device 10 having a stroke sensor 1 as a position detection device according to an embodiment of the present invention.

As shown in FIG. 1, the steering device 10 comprises a stroke sensor 1, tie rods 12 connected to steerable wheels 11 (left and right front wheels), a rack shaft 13 connected to the tie rods 12, a cylindrical housing 14 for accommodating the rack shaft 13, a worm reduction mechanism 15 having a pinion gear 151 meshed with a rack teeth 131 of the rack shaft 13, an electric motor 16 that imparts axial movement force to the rack shaft 13 via the worm reduction mechanism 15, a steering wheel 17 to be operated by the driver, a steering angle sensor 18 for detecting a steering angle of the steering wheel 17, and a steering controller 19 for controlling the electric motor 16 based on the steering angle detected by the steering angle sensor 18.

In FIG. 1, the housing 14 is shown in a virtual line (phantom). The rack shaft 13 is supported by a pair of rack bushings 100 attached to both ends of the housing 14. The rack bushings 100 are composed of, for example, a combination of synthetic resin, such as polyacetal resin, polyamide resin, or polyethylene resin, and elastic members such as rubber. The worm reduction mechanism 15 has a worm wheel 152 and a worm gear 153, and the pinion gear 151 is attached to the worm wheel 152. The worm gear 153 is attached to a motor shaft 161 of the electric motor 16.

The electric motor 16 generates torque by a motor current supplied from the steering controller 19 and rotates the worm wheel 152 and the pinion gear 151 via the worm gear 153. When the pinion gear 151 rotates, the rack shaft 13 moves forward and backward in its axial direction, and the left and right steerable wheels 11 are steered. The rack shaft 13 can move rightward and leftward in a vehicle width direction within a predetermined range from a neutral position when the steering angle is zero. In FIG. 1, a double arrow indicates a range R₁ where the rack shaft 13 can move in the axial direction.

### (Structure of Stroke Sensor 1)

The stroke sensor 1 includes a target 2 made of an electrically conductive metal as a detection object, a substrate 3 arranged to face the target 2, a power supply unit 4, and a calculation unit 5. The substrate 3 is arranged to extend parallel to the moving direction of the rack shaft 13. The stroke sensor 1 detects the position of the rack shaft 13 with respect to the housing 14 based on the position of the target 2 and outputs information on the detected position to the steering controller 19. The rack shaft 13 moves axially forward and backward without rotating with respect to the housing 14. The steering controller 19 controls the electric motor 16 in such a manner that the position of the rack shaft 13 detected by the stroke sensor 1 corresponds to the steering angle of the steering wheel 17 detected by the steering angle sensor 18.

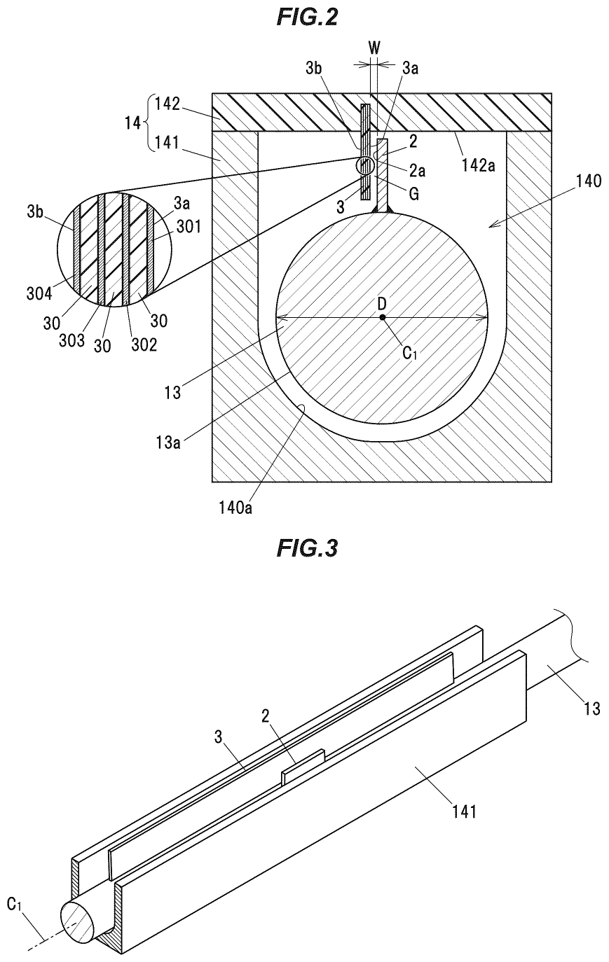

FIG. 2 is a cross-sectional view of the rack shaft 13, the housing 14, the target 2, and the substrate 3 taken along line A-A in FIG. 1. FIG. 3 is a perspective view showing the rack shaft 13, the main body 141 of the housing 14, the target 2, and the substrate 3. In FIGS. 2 and 3, the vertical direction of the drawings corresponds to the vertical up and down direction when the stroke sensor 1 is mounted on a vehicle. In the following explanation, “up” and “down” refer to up and down direction in the vertical direction when the stroke sensor 1 is mounted on a vehicle.

The rack shaft 13 is a rod-shaped moving member with a circular cross-section made of steel, such as carbon steel. The housing 14 has the main body 141 made of metal and a lid 142 made of resin, and the lid 142 is attached to the main body 141 by, e.g., adhesion. The main body 141 has a U-shaped cross-section in which an accommodation space 140 for accommodating the rack shaft 13 is formed, and the accommodation space 140 opens upward in the vertical direction.

In FIGS. 2 and 3, a central axis of the rack shaft 13 is indicated by the sign C₁. The position of the central axis C₁ in a cross-section perpendicular to the axial direction of the rack shaft 13 is the position of the center of gravity in that cross-section. A diameter D of the rack shaft 13 is, e.g., 25 mm. In the present embodiment, the rack shaft 13 is formed to have a circular cross-section, but the cross-section of the rack shaft 13 is not limited to a circle but may be in a D-shape in which a part is formed in a straight line or in a polygonal shape.

A gap of, e.g., 1 mm or more is formed between an outer peripheral surface 13a of the rack shaft 13 and an inner surface 140a of the accommodation space 140. The lid 142 is formed in a flat plate shape and covers the accommodation space 140 from above in the vertical direction. The main body 141 is made of die-cast aluminum alloy, for example.

The substrate 3 is partially embedded in the lid 142 and secured to the lid 142. The lid 142 is insert molded to be integral with the substrate 3, and a portion of the substrate 3 protrudes from a lower surface 142a on a rack shaft 13-side in the lid 142 toward the rack shaft 13. The portion of the substrate 3 protruding downward from the lid 142 faces the target 2.

The target 2 is a target for showing the position of the rack shaft 13 with respect to the stroke sensor 1. In the present embodiment, the target 2 is formed in a flat plate shape and protrudes upward from the outer peripheral surface 13a of the rack shaft 13 toward the lid 142. In the present embodiment, the target 2 is fixed to the outer peripheral surface 13a of the rack shaft 13 by welding, but a fixing method of the target 2 is not limited thereto. For example, the target 2 may be fixed to the rack shaft 13 by bolting.

The target 2 has a rectangular parallelepiped (cuboid) shape that is lengthy in the axial direction of the rack shaft 13 when viewed from a substrate 3-side. A facing surface 2a of the target 2, which faces the substrate 3, is formed in a flat plate shape. A non-magnetic metal such as an aluminum alloy or copper, which has a higher conductivity than the rack shaft 13, can be suitably used as the material of the target 2. Iron may also be used as the material of the target 2, and the conductivity of the target 2 may be the same as that of rack shaft 13. A protrusion on the rack shaft 13 may also be used as the target 2. The protrusions on the rack shaft 13 may also be used as the target 2. The facing surface 2a of the target 2 faces parallel to a front surface 3a of the substrate 3 through an air gap G. A width W of the air gap G is, e.g., 1 mm.

The substrate 3 is a four-layered substrate in which layers of a plate-shaped base material 30 made of a dielectric material such as FR4 (glass fiber impregnated with epoxy resin and heat-cured) are provided between the first to fourth metal layers 301 to 304. The thickness of each base material 30 is, e.g., 0.3 mm. Each of the first to fourth metal layers 301 to 304 has a thickness of, e.g., 18 μm. The substrate 3 has a flat rectangular shape whose longitudinal direction is the axial direction of the rack shaft 13.

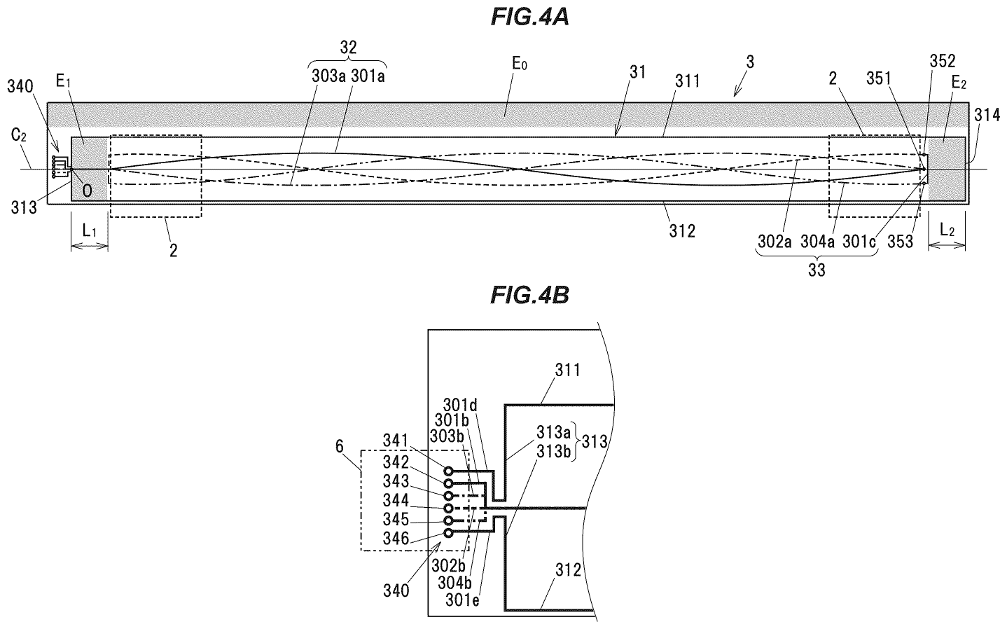

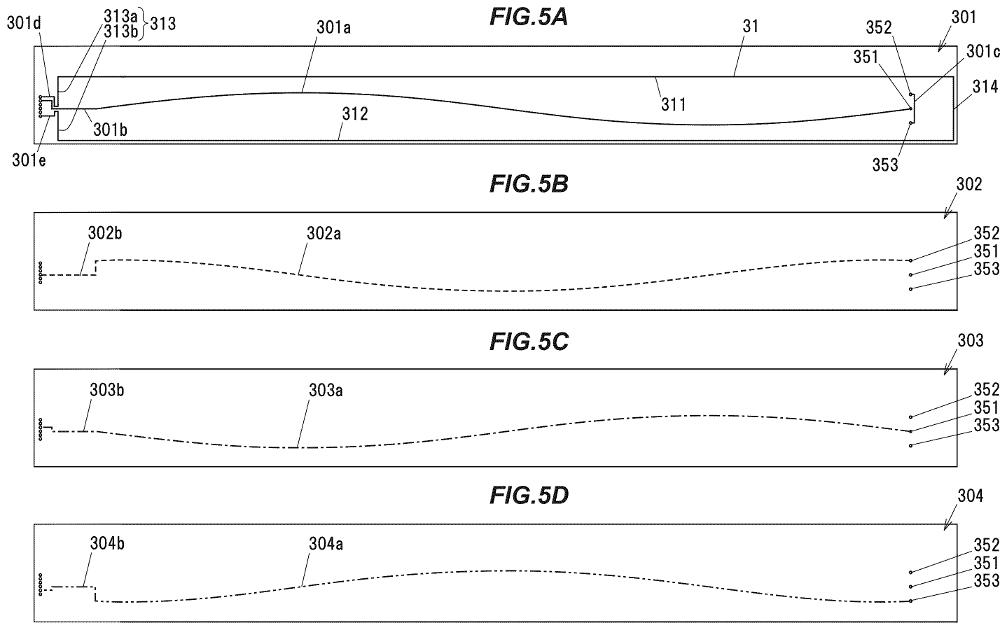

FIG. 4A is an overall view of the wiring patterns formed on the first to fourth metal layers 301 to 304 of the substrate 3 as seen through from a front surface 3a-side toward a back surface 3b-side. FIG. 4B is a partially enlarged view of FIG. 4A. FIGS. 5A to 5D are plan views showing the first to fourth metal layers 301 to 304, respectively, viewed from the front surface 3a-side. The wiring patterns shown in FIGS. 4A and 4B and FIGS. 5A to 5D are merely examples, and various wiring patterns may be used as long as the substrate 3 is formed so as to obtain the effects of the present invention.

In FIG. 4A, a held region E₀ of the substrate 3 to be held embedded in the lid 142 is shown in gray shading. The held region E₀ is a strip-shaped region at one end of the substrate 3 in the shortitudinal direction. In order to securely hold the substrate 3 in the lid 142, for example, a through-hole penetrating through the substrate 3 may be formed in the held region E₀.

In FIG. 4A and FIGS. 5A to 5D, the wiring pattern of the first metal layer 301 is indicated by solid lines, the wiring pattern of the second metal layer 302 is indicated by broken lines, the wiring pattern of the third metal layer 303 is indicated by a one-dot chain line, and the wiring pattern of the fourth metal layer 304 is indicated by a two-dot chain line. In FIG. 4A, the substrate 3 is bisected in the shortitudinal direction and a central axis C₂ extending in the longitudinal direction is indicated by a gray straight line, and the dotted lines indicate the positions of the target 2 when the rack shaft 13 is positioned at one end and the other end of the range in which the stroke sensor 1 can detect the absolute position of the rack shaft 13.

A connector portion 340 having first to sixth through-holes 341 to 346 through which connector pins of the connector 6 indicated by two-dot chain lines in FIG. 4B is provided at one end of the substrate 3 in the longitudinal direction. The first to sixth through-holes 341 to 346 are arranged linearly along the shortitudinal direction of the substrate 3. The connector 6 is connected with a connector 71 (see FIG. 1) of the cable 7 for connection with the power supply unit 4 and the calculation unit 5. Further, the substrate 3 is formed with first to third vias 351 to 353 for connecting the wiring patterns between layers.

The first metal layer 301 includes a first curved portion 301a, a first connector-connecting portion 301b connecting one end of the first curved portion 301a to a second through-hole 342, and an end-connecting portion 301c connecting respective ends of a second curved portion 302a to be described later and a fourth curved portion 304a. The second metal layer 302 includes the second curved portion 302a, and a second connector-connecting portion 302b connecting one end of the second curved portion 302a to a fourth through-hole 344. The third metal layer 303 includes a third curved portion 303a, and a third connector-connecting portion 303b connecting one end of the third curved portion 303a to a third through-hole 343. The fourth metal layer 304 includes a fourth curved portion 304a, and a fourth connector-connecting portion 304b connecting one end of the fourth curved portion 304a to a fifth through-hole 345.

The other ends of the first curved portion 301a and the third curved portion 303a are connected to each other by a first via 351. One end of the end-connecting portion 301c is connected to the other end of the second curved portion 302a by a second via 352, and the other end of the end-connecting portion 301c is connected to the other end of the fourth curved portion 304a by a third via 353.

The first to fourth curved portions 301a, 302a, 303a, and 304a are curved in a substantially sine wave shape. The first curved portion 301a and the third curved portion 303a, and the second curved portion 302a and the fourth curved portion 304a are symmetrical with respect to the central axis C₂ of the substrate 3. The central axis C₂ is parallel to the axial direction of the rack shaft 13, i.e., the moving direction of the rack shaft 13.

The substrate 3 includes an excitation coil 31 that generates a magnetic field in a range including the target 2, and two detection coils 32 and 33 with which the magnetic flux of the magnetic field generated by the excitation coil 31 interlinks. The excitation coil 31 and the two detection coils 32, 33 are formed in the portion facing the target 2 when the rack shaft 13 moves. Of the two detection coils 32 and 33, one detection coil 32 is formed by the first curved portion 301a and the third curved portion 303a, and the other detection coil 33 is formed by the second curved portion 302a, the fourth curved portion 304a, and the end-connecting portion 301c. The calculation unit 5 determines the position of the rack shaft 13 by calculation using the output voltages of the two detection coils 32 and 33.

The excitation coil 31 has a rectangular shape having a pair of long side portions 311 and 312 extending in the axial direction of the rack shaft 13 and a pair of short side portions 313 and 314 between the pair of long side portions 311 and 312, and the detection coils 32, 33 are formed inside this rectangular-shaped excitation coil 31. The pair of long side portions 311, 312 form the long sides of the rectangular shape, and the pair of short side portions 313, 314 form the short sides of the rectangular shape.

In this embodiment, the long side portions 311 and 312 and the short side portions 313 and 314 are formed as wiring patterns on the first metal layer 301. Of the pair of short side portions 313 and 314, the short side portion 313 on the side of the connector portion 340 is composed of two straight portions 313a and 313b sandwiching the first to fourth connector connection portions 301b, 302b, 303b and 304b. The ends of the two straight portions 313a and 313b are connected to the first through-hole 341 and the sixth through-hole 346 by connector-connecting portions 301d and 301e formed in the first metal layer 301, respectively. The excitation coil 31 may be formed not only on the first metal layer 301 but also on any of the second to fourth metal layers 302 to 304 or may be formed over a plurality of layers.

A sine wave AC current is supplied to the excitation coil 31 from the power supply unit 4. Eddy currents are generated in the target 2 by the magnetic flux generated by the AC current supplied to the excitation coil 31. The magnetic field generated by this eddy current acts to weaken the magnetic field generated by the excitation coil 31, and the magnetic flux density in the part of the substrate 3 facing the target 2 becomes lower than in other parts. Induced voltage is generated in the two detection coils 32 and 33 by the magnetic flux of the magnetic field generated by the excitation coil 31, and the peak value of the voltage induced in the detection coils 32 and 33 varies according to the position of the target 2 relative to the substrate 3. The peak value of the voltage refers to the maximum value of the absolute value of the voltage within a period of one cycle of the alternating current supplied to the excitation coil 31.

The phases of the voltages induced in the detection coils 32 and 33 are different from each other while the rack shaft 13 moves from one movement end in the axial direction to the other movement end in the axial direction. In this embodiment, the phases of the voltages induced in the detection coils 32 and 33 differ by 90°. Hereinafter, of the two detection coils 32 and 33, one detection coil 32 is referred to as a sine wave-shaped detection coil 32, and the other detection coil 33 is referred to as a cosine wave-shaped detection coil 33.

The peak value of the voltage induced in the sine wave-shaped detection coil 32 and the cosine wave-shaped detection coil 33 due to the interlinking of the magnetic flux of the target 2 changes within the range of one cycle or less while the rack shaft 13 moves one movement end to the other movement end in the axial direction. Thereby, the stroke sensor 1 can detect the absolute position of the rack shaft 13 over the entire range R₁ in which the rack shaft 13 can move in the axial direction.

As shown in FIG. 4A, between respective ones of the pair of short side portions 313 and 314 of the excitation coil 31, the sine wave-shaped detection coil 32, and the cosine wave-shaped detection coil 33, there are provided first and second buffer regions E₁, E₂ for suppressing voltages induced in the sine wave-shaped detection coil 32 and the cosine wave-shaped detection coil 33 by the magnetic flux generated by the current flowing through the short side portions 313 and 314. In the example shown in FIG. 4A, a length L₁ of the first buffer region E₁ and a length L₂ of the second buffer region E₂ in the longitudinal direction of the substrate 3 are the same, but L₁ and L₂ may be different from each other.

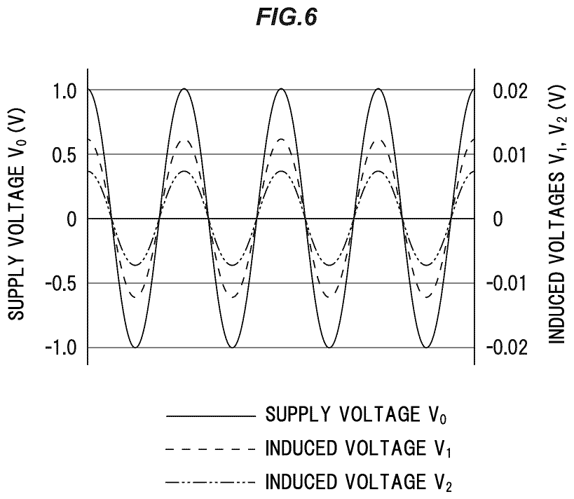

Next, the operation of the stroke sensor 1 for detecting the position of the target 2 with respect to the substrate 3 will be described with reference to FIGS. 6 to 8. In the following description, the position of the target 2 means the center position of the target 2 in the longitudinal direction of the substrate 3.

FIG. 6 is a graph showing the relationship between a supply voltage V₀ supplied from the power supply unit 4 to the excitation coil 31, an induced voltage V₁ induced in the sine wave-shaped detection coil 32, and an induced voltage V₂ induced in the cosine wave-shaped detection coil 33. The horizontal axis of the graph in FIG. 6 is the time axis, and the left and right vertical axes indicate the supply voltage V₀ and the induced voltages V₁ and V₂.

In the example shown in FIG. 6, the supply voltage V₀ supplied to the excitation coil 31 and the induced voltages V₁ and V₂ induced in the sine wave-shaped detection coil 32 and the cosine wave-shaped detection coil 33 are in phase. However, the induced voltage V₁ induced in the sine wave-shaped detection coil 32 switches between the in-phase and the reverse phase each time the target 2 passes through the position where the first curved portion 301a and the third curved portion 303a are crossing. In addition, the induced voltage V₂ induced in the cosine wave-shaped detection coil 33 switches each time the target 2 passes the position where the second curved portion 302a and the fourth curved portion 304a are crossing. A high-frequency AC voltage of, e.g., about 1 MHz to 1 GHz is supplied to the excitation coil 31 as a supply voltage V₀.

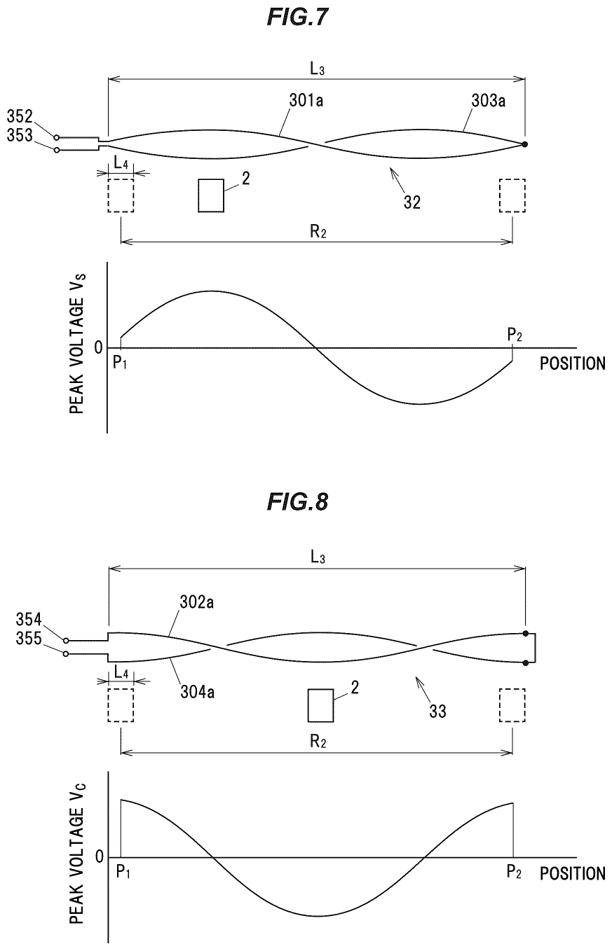

FIG. 7 is an explanatory diagram schematically showing the relationship between the peak voltage V_{S}, which is the peak value of the induced voltage V₁ induced in the sine wave-shaped detection coil 32, and the position of the target 2. FIG. 8 is an explanatory diagram schematically showing the relationship between the peak voltage V_{C}, which is the peak value of the induced voltage V₂ induced in the cosine wave-shaped detection coil 33, and the position of the target 2. In the graphs of the peak voltages V_{S} and V_{C} shown in FIGS. 7 and 8, the horizontal axis indicates the position of the target 2.

The stroke sensor 1 can detect an absolute position of the target 2 within an axial range R₂ in which the length La of the target 2 in the longitudinal direction of the substrate 3 is subtracted from the length L₃ of the sine wave-shaped detection coil 32 and the cosine wave-shaped detection coil 33 in the longitudinal direction of the substrate 3. In the graphs shown in FIGS. 7 and 8, the peak voltages V_{S} and V_{C} are shown at respective positions where the horizontal axis coordinate when the target 2 is at one end (the end on the side of the connector portion 340) of the axial range R₂ is P₁, and the horizontal axis coordinate when the target 2 is at the other end of the axial range R₂ is P₂. The original position of the horizontal axis is the position of the short side portion 313 of the excitation coil 31, indicated by point O in FIG. 4A.

Further, in the graphs shown in FIGS. 7 and 8, the peak voltage V_{S} of the sine wave-shaped detection coil 32 has a positive value when the induced voltage V₁ induced in the sine wave-shaped detection coil 32 is in phase with the supply voltage V₀ supplied to the excitation coil 31 and has a negative value when the phase is opposite. Similarly, the peak voltage V_{C} of the cosine wave-shaped detection coil 33 has a positive value when the induced voltage V₂ induced in the cosine wave-shaped detection coil 33 is in phase with the supply voltage V₀ supplied to the excitation coil 31, and has a negative value when the phase is opposite.

Here, if ωx is defined as in Formula [1], the peak voltages V_{S} and V_{C} are obtained by Formula [2] and Formula [3], where Xp is the coordinate value of the horizontal axis of the target 2 in the graphs shown in FIGS. 7 and 8. Note that A in Formula [2] and Formula [3] is a predetermined constant.

$$[ Formula 1 ]$$

$${ω}_{x} = \frac{2 π}{{L}_{3}} \qquad [ 1 ]$$

$$[ Formula 2 ]$$

$$Vs = A sin \{ ( {ω}_{x} ( {X}_{p} - {L}_{1} ) \} \qquad [ 2 ]$$

$$[ Formula 3 ]$$

$$Vc = A cos \{ ( {ω}_{x} ( {X}_{p} - {L}_{1} ) \} \qquad [ 3 ]$$

From Formula [2] and Formula [3], the coordinate value Xp of the target 2 in the graphs shown in FIGS. 7 and 8 is obtained by Formula [4]. That is, the calculation unit 5 can calculate the position of the target 2 based on the peak voltages Vs and Vc.

$$[ Formula 4 ]$$

$${X}_{p} = \frac{arc tan ( \frac{Vs}{Vc} )}{{ω}_{x}} + {L}_{1} \qquad [ 4 ]$$

By the way, when the distance between the substrate 3 and the target 2 changes due to vibration caused by, for example, vehicle driving, even if the position of the target 2 relative to the substrate 3 is unchanged, the intensity of the magnetic field in the sine wave-shaped detection coil 32 and the cosine wave-shaped detection coil 33 changes and the peak voltages V_{S} and V_{C} vary, errors occur in the detection results of the position of the target 2 calculated by the calculation unit 5. In particular, when the vehicle is traveling on uneven terrain, vertical vibration is easily transmitted from the steerable wheels 11 through the tie rods 12 to the rack shaft 13.

For this reason, the stroke sensor 1 has a spacing fluctuation suppression structure that suppresses variation in the spacing (air gap G) between the front surface 3a, which is the facing surface with the target 2, and the target 2 in the substrate 3. In the present embodiment, this spacing fluctuation suppression structure is a structure in which the front surface 3a of the substrate 3 faces the target 2 and the rack shaft 13 in the circumferential direction around the central axis C₁ of the rack shaft 13.

The front surface 3a of the substrate 3 faces the target 2 and the rack shaft 13 circumferentially around the central axis C₁ of the rack shaft 13, thereby suppressing fluctuations in the distance between the substrate 3 and the target 2 even when the rack shaft 13 vibrates in its radial direction. This reduces the fluctuation range of the peak voltages V_{S} and V_{C} caused by the vibration of the rack shaft 13 and improves the detection accuracy of the position of the target 2.

In particular, since the target 2 is provided vertically above the rack shaft 13, and the substrate 3 and the target 2 face each other horizontally, the distance between the substrate 3 and the target 2 can be kept substantially constant even when rack shaft 13 vibrates vertically. The target 2 may be installed vertically below the rack shaft 13 and the substrate 3 may be oriented parallel to this target 2. In this case, the detection accuracy of the position of the target 2 can still be improved in the same way as when the target 2 is provided vertically above the rack shaft 13.

According to the present embodiment, even if the rack shaft 13 is eccentric with respect to the housing 14 due to deformation (denting) of the rack bushing 100 caused by long-term use, for example, the distance between the substrate 3 and the target 2 can be kept substantially constant, thereby preventing a decrease in the detection accuracy of the position of the target 2. This can suppress the decline in detection accuracy of the position of the target 2.

### Modified Example 1 of the First Embodiment

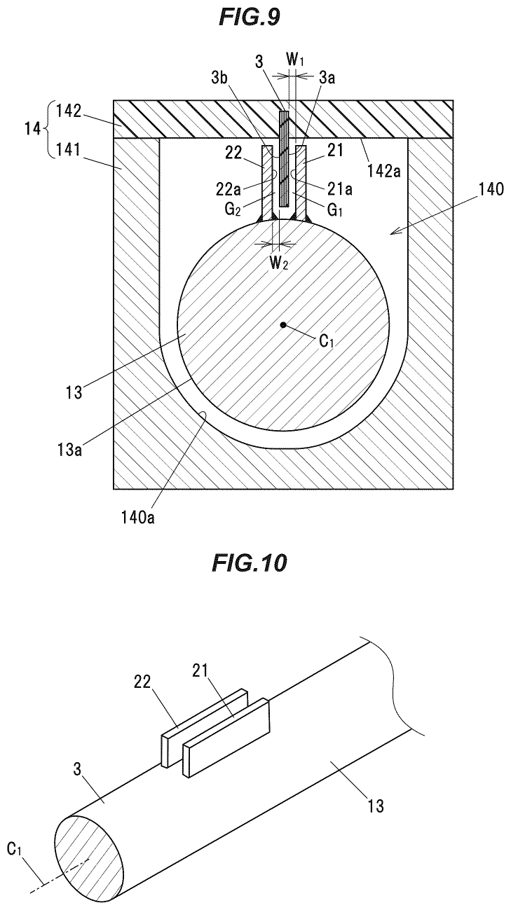

Next, modified example 1 of the first embodiment is explained with reference to FIGS. 9 and 10. FIG. 9 is a cross-sectional view of the rack shaft 13 according to the modified example 1 and its peripheral parts. FIG. 10 is a perspective view of a portion of the rack shaft according to the modified example 1 of the first embodiment, viewed from diagonally above. In FIGS. 9 and 10, the vertical direction of the drawings corresponds to vertical up and down.

In the first embodiment described above, a single target 2 is provided on the rack shaft 13. In the modified example 1 shown in FIGS. 9 and 10, first and second targets 21, 22 as two detection objects are provided on the rack shaft 13 so as to sandwich the substrate 3 in its thickness direction. The first target 21 faces the front surface 3a of the substrate 3 and the second target 22 faces the back surface 3b of the substrate 3. The front surface 3a of the substrate 3 is the surface facing the first target 21 and the back surface 3b of the substrate 3 is the surface facing the second target 22.

The first and second targets 21, 22 are rectangular parallelepiped (cuboid) in shape, long in the axial direction of the rack shaft 13, as in the first embodiment above, and are provided vertically above the rack shaft 13, facing parallel to the substrate 3. A facing surface 21a of the first target 21 facing the front surface 3a of the substrate 3 and a facing surface 22a of the second target 22 facing the back surface 3b of the substrate 3 are both flat. The first and second targets 21, 22 are made of electrically conductive metal plates, such as aluminum alloy or copper, for example, as in the target 2 of the first embodiment above.

The front surface 3a of the substrate 3 faces the first target 21 circumferentially around the central axis C₁ of the rack shaft 13. The back surface 3b of the substrate 3 faces the second target 22 circumferentially around the central axis C₁ of the rack shaft 13. A width W₁ of an air gap G₁ between the front surface 3a of the substrate 3 and the first target 21 and a width W₂ of an air gap G₂ between the back surface 3b of the substrate 3 and the second target 22 are each, e.g., 1 mm.

According to this modified example 1, for example, even if the rack shaft 13 vibrates in the front-back (horizontal) direction of the vehicle, if the width W₁ of the air gap G₁ increases, the width W₂ of the air gap G₂ decreases, and if the width W₁ of the air gap G₁ decreases, the width W₂ of the air gap G₂ increases, so the total gap between the substrate 3 and the first and second targets 21, 22 can be kept constant. As a result, the fluctuation range of the peak voltages V_{S} and V_{C} caused by the vibration of the rack shaft 13 becomes even smaller than in the first embodiment above, and the detection accuracy of the position of the target 2 is enhanced.

### Modified Example 2 of the First Embodiment

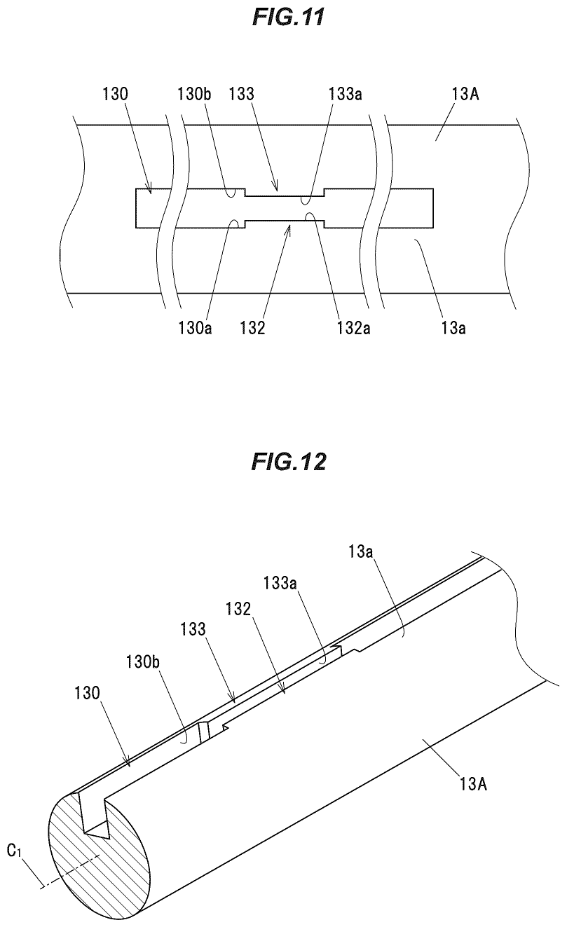

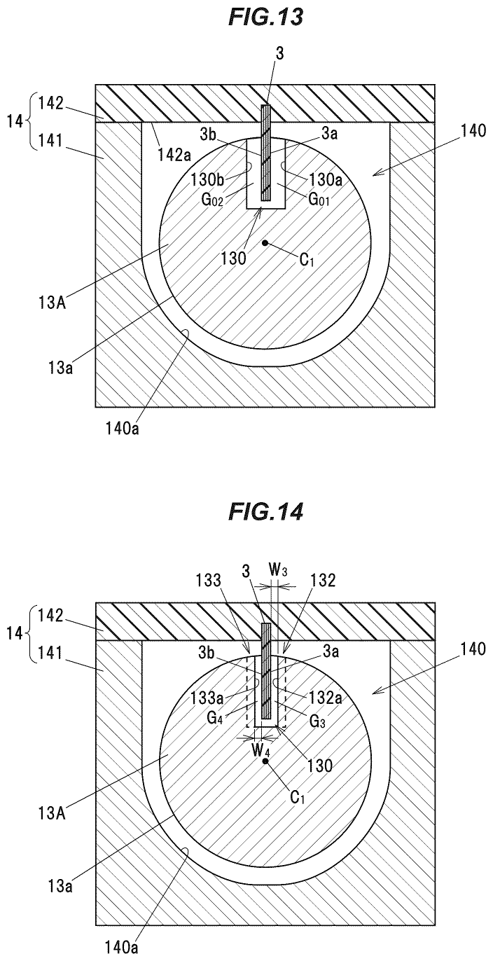

Next, modified example 2 of the first embodiment will be explained with reference to FIGS. 11 to 14. FIG. 11 is a configuration diagram of a rack shaft 13A according to a modified example 2 of the first embodiment, viewed from above in the vertical direction. FIG. 12 is a perspective view of a portion of the rack shaft 13A according to the modified example 2 of the first embodiment, viewed from diagonally above. FIGS. 13 and 14 are cross-sectional views of the rack shaft 13A and its peripheral parts according to the modified example 2 of the first embodiment. In FIGS. 12 to 14, the vertical direction of the drawings corresponds to vertical up and down. The rack shaft 13A, like the rack shaft 13 of the first embodiment, is a rod-shaped moving member with a circular cross-section made of steel, such as carbon steel, and functions as a steering shaft to steer the left and right front wheels.

In the modified example 2, a recess 130 is formed in the form of a slit in a longitudinal part of the rack shaft 13A. The recess 130 accommodates a portion of the substrate 3 in which the excitation coil 31 as well as the sine wave-shaped detection coil 32 and the cosine wave-shaped detection coil 33 are formed. The recess 130 extends along the axial direction of the rack shaft 13A, which is the moving direction of the rack shaft 13A relative to the housing 14, and is formed to be recessed from an outer peripheral surface 13a of the rack shaft 13A toward the central axis C₁.

Facing surfaces 130a and 130b with the substrate 3 in the recess 130 protrude toward the substrate 3 in part of the axial direction of the rack shaft 13A, and these protruding portions are formed as the first and second detection portions 132 and 133. The first detection portion 132 has a facing surface 132a facing the front surface 3a of the substrate 3, and the second detection portion 133 has a facing surface 133a facing the back surface 3b of the substrate 3. The facing surfaces 130a and 130b of the first and second detection portions 132 and 133 are planar surfaces parallel to the substrate 3. The recess 130 of such a shape can be formed by a cutting process using, for example, a blade tool such as an end mill.

As shown in FIG. 14, the facing surface 132a of the first detection portion 132 and the front surface 3a of the substrate 3 face each other circumferentially around the central axis C₁ of the rack shaft 13A via an air gap G₃. The facing surface 133a of the second detection portion 133 and the back surface 3b of the substrate 3 face each other circumferentially around the central axis C₁ of the rack shaft 13A via an air gap G₄. A width W₃ of the air gap G₃ and a width W₄ of the air gap G₄ are, e.g., 1 mm, respectively.

The first detection portion 132 and the second detection portion 133 are formed at the same position in the longitudinal direction of the rack shaft 13A. When the substrate 3 is not accommodated in the recess 130, the facing surface 132a of the first detection portion 132 and the facing surface 133a of the second detection portion 133 face each other in parallel. The front surface 3a of the substrate 3 is the facing surface of the first detection portion 132 and the back surface 3b of the substrate 3 is the facing surface of the second detection portion 133.

One facing surface 130a with the substrate 3 in the recess 130 faces the front surface 3a of the substrate 3 via an air gap G₀₁ of a width wider than the width W₃ of the air gap G₃, except for the portion where the first detection portion 132 is formed. The other facing surface 130b with the substrate 3 in the recess 130 faces the back surface 3b of the substrate 3 via an air gap G₀₂ of a width wider than the width W₄ of the air gap G₄, except for the portion where the second detection portion 133 is formed. This results in a lower magnetic flux density in the portion of the substrate 3 facing the first and second detection portions 132, 133 than in other portions of the substrate 3.

According to this modified example 2, even if the rack shaft 13A vibrates in the vertical direction, the distance between the substrate 3 and the first and second detection portions 132, 133 can be kept constant. Even if the rack shaft 13A vibrates in the front-back (horizontal) direction of the vehicle, if the width W₃ of one air gap G₃ of the air gaps G₃, G₄ on the front surface 3a-side and the back surface 3b-side of the substrate 3 becomes larger, the width W₄ of the other air gap G₄ will become smaller, and if the width W₃ of one air gap G₃ becomes smaller, the width W₄ of the other air gap G₄ will become larger, so that the total gap between the substrate 3 and the first and second detection portions 132, 133 can be kept constant. This reduces the fluctuation range of the peak voltages V_{S} and V_{C} caused by the vibration of the rack shaft 13A, thereby increasing the position detection accuracy.

### Second Embodiment

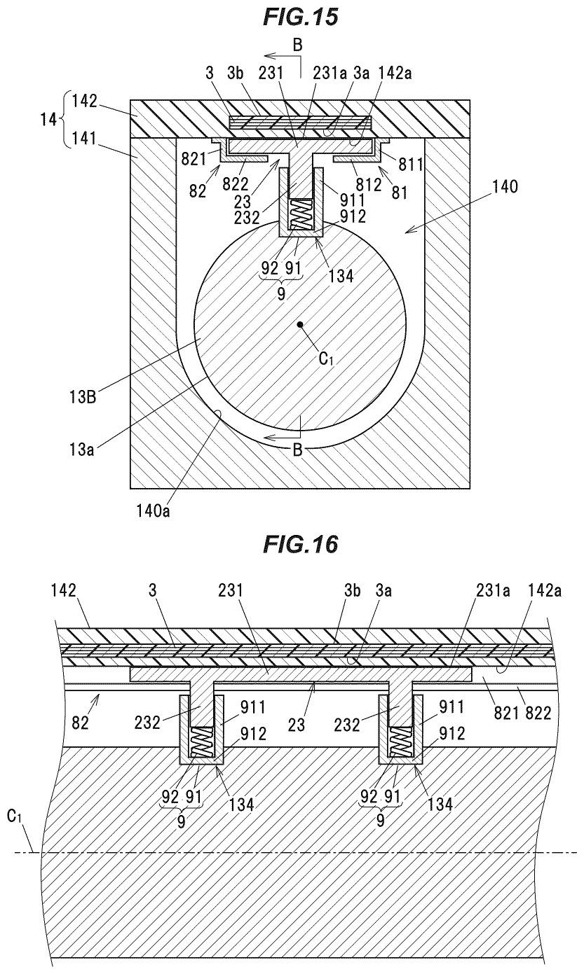

The second embodiment of the invention will now be described with reference to FIGS. 15 and 16. In this second embodiment, as in the first embodiment, the substrate 3 is extended and arranged parallel to a rack shaft 13B housed in the housing 14, and the rack shaft 13B moves axially forward and backward, but the normal direction of the substrate 3 perpendicular to the front surface 3a and the back surface 3b of the substrate 3 is the vertical direction. FIG. 15 is a cross-sectional view of the rack shaft 13B and its peripheral parts according to the modified example 2 of the first embodiment in a cross-section perpendicular to the axial direction of the rack shaft 13B. FIG. 16 is a cross-sectional view taken along line B-B of FIG. 15, showing the rack shaft 13B and its peripheral parts in cross-section along the central axis C₁ of the rack shaft 13B. In FIGS. 15 and 16, the vertical direction of the drawings corresponds to vertical up and down.

In the present embodiment, the entire substrate 3 is embedded in a lid 142 of the housing 14, and a target 23 as a detection object is positioned to face a lower surface 142a of the lid 142. The target 23 is made of electrically conductive metal, such as aluminum alloy or copper, for example, as in the case of the target 2 of the first embodiment. The target 23 integrally comprises a flat shaped plate portion 231 having a facing surface 231a facing the lower surface 142a of the lid 142, and a plurality of cylindrical column portions 232 projecting downward from the plate portion 231 toward the rack shaft 13B.

In the present embodiment, a pair of guide members 81, 82 that guide the target 23 in the moving direction of the rack shaft 13B are fixed to the lid 142. The pair of guide members 81, 82 have side plates 811, 821 provided in a position that sandwiches the plate portion 231 of the target 23 in the shortitudinal direction of the substrate 3 (left-right direction in FIG. 15) and support portions 812, 822 provided in a position that sandwiches a portion of the plate portion 231 between it and the lid 142. The support portions 812, 822 support the plate portion 231 of the target 23 from below to prevent the target 23 from falling off a rack shaft 13B-side. The support portions 812, 822 may be omitted.

The plurality of column portions 232 of the target 23 protrude downward toward the rack shaft 13B from between the support portion 812 of one guide member 81 and the support portion 822 of the other guide member 82 of the pair of guide members 81 and 82. The rack shaft 13B is provided with a force-applying mechanism unit (energizing mechanism portion) 9 that supports the column portions 232 of the target 23 and also forces the target 23 toward the lower surface 142a of the lid 142. The force-applying mechanism unit 9 has a bottomed cylindrical housing member 91 that accommodates longitudinal portions in part of the column portions 232 of the target 23, and an elastic member 92 that is housed in the housing member 91 together with the portions in part of the column portions 232.

The housing member 91 has a cylindrical portion 911 and a bottom portion 912 that closes one end of the cylindrical portion 911. The housing member 91 is secured to the rack shaft 13B by fitting a portion of a bottom portion 912-side into a fitting hole 134 formed in the rack shaft 13B. The housing member 91 may be secured to the rack shaft 13B by welding, for example. The elastic member 92 is a coil spring, for example, and is housed in a compressed state between the bottom portion 912 of the housing member 91 and the column portions 232 of the target 23. The force-applying mechanism unit 9 presses the plate portion 231 of the target 23 against the lower surface 142a of the lid 142 by the restoring force of the elastic member 92.

The target 23 moves forward and backward together with the rack shaft 13B, and a facing surface 231a of the plate portion 231 slides on the lower surface 142a of the lid 142 during this movement. The column portions 232 are provided at multiple locations in the moving direction of the target 23, and the force-applying mechanism unit 9 is provided on the rack shaft 13B corresponding to each of the column portions 232. In the example shown in FIG. 16, the target 23 has two column portions 232, but the number of column portions 232 is not limited to this, and may be one, three or more.

In the present embodiment, even if the rack shaft 13B vibrates in the vertical direction, this vibration is absorbed by the elastic member 72 and the distance between the substrate 3 and the target 23 is kept constant. In other words, in the present embodiment, the spacing fluctuation suppression structure that suppresses fluctuations in the spacing between the substrate 3 and the target 23 is realized by applying the force to the target 23, which is a separate body from the rack shaft 13B, in the direction normal to the substrate 3 by the force-applying mechanism unit 9, and this improves the detection accuracy of the position of the target 23. The plate portion 231 of the target 23 may be attached to the support portions 812, 822 of the pair of guide members 81, 82. Even in this case, fluctuations in the distance between the substrate 3 and the target 23 can be suppressed.

### Summary of Embodiment and Modified Example

Next, technical ideas understood from the embodiments and modified examples described above will be described with reference to the reference numerals and the like in the embodiments and examples. However, each reference numeral in the following description does not limit the constituent elements in the claims to the members and the like specifically shown in the embodiments and modified examples.

According to the first feature, a position detection device (stroke sensor) 1 for detecting a position of a moving member (rack shaft) 13, 13A, 13B moving forward and backward in a predetermined moving direction, includes a detection object (targets) 132, 133, 2, 21, 22, 23 attached to the moving member 13, 13A, 13B, a substrate 3 provided with an excitation coil 31 being positioned to face the moving member 13, 13A, 13B and parallel to the moving direction of the moving member 13, 13A, 13B for generating a magnetic field in an area including the detection object 132, 133, 2, 21, 22, 23, and a detection coil 32, 33 being interlinked with a magnetic flux of the magnetic field, a power supply unit 4 for supplying an alternating current to the excitation coil 31, a calculation unit 5 that calculates the position of the moving member 13, 13A, 13B based on an output voltage of the detection coil 32, 33, and a spacing fluctuation suppression structure that suppresses fluctuations in a spacing between a facing surface 3a, 3b facing the detection object 132, 133, 2, 21, 22, 23 and the detection object 132, 133, 2, 21, 22, 23 in the substrate 3.

According to the second feature, in the position detection device 1 as described by the first feature, the spacing fluctuation suppression structure is a structure in which the facing surface 3a, 3b of the substrate 3 faces the detection object 132, 133, 2, 21, 22 circumferentially around a central axis C₁ of the moving member 13, 13A.

According to the third feature, in the position detection device 1 as described by the second feature, the moving member 13, 13A is a rod-shaped shaft and the detection object 132, 133, 2, 21, 22 is provided protruding from an outer peripheral surface 13a of the shaft.

According to the fourth feature, in the position detection device 1 as described by the third features, the detection object 21, 22 is composed of two detection objects 21, 22 provided on the shaft 13 so as to sandwich the substrate 3 in a thickness direction.

According to the fifth feature, in the position detection device 1 as described by the second feature, a slit-shaped recess 130 is formed in the moving member 13A along the moving direction, and a portion of the substrate 3 in which the excitation coil 31 and the detection coil 32, 33 are formed is accommodated in the recess 130, and a facing surface 130a, 130b of the recess 130 facing the substrate 3 protrudes toward the substrate 3 in a part of the moving direction, and the protruded portion is formed as the detection object 132, 133.

According to the sixth feature, in the position detection device 1 as described by the first feature, the spacing fluctuation suppression structure is a structure that applies a force to the detection object 23, which is a separate body from the moving member 13B, in a normal direction of the substrate 3.

According to the seventh feature, in the position detection device 1 as described by any one of the first to sixth features, the detection coil 32, 33 is composed of two detection coils 32, 33 provided on the substrate 3, and phases of the voltages induced in the respective two detection coils 32, 33 while the moving member 13 moves from one moving end to the other moving end are different from each other.

According to the eighth feature, in the position detection device 1 as described by the first feature, the moving member 13, 13A, 13B is a rack shaft of a steering device 10 of a vehicle.

Although the embodiment and modified example of the present invention has been described above, the embodiment and modified example described above do not limit the invention according to the scope of claims. Also, it should be noted that not all combinations of features described in the embodiment and modified example are essential to the means for solving the problems of the invention. In addition, the invention can be implemented by modifying it as appropriate to the extent that it does not depart from the gist of the invention, for example, it can be implemented by the following modifications.

In the above embodiment, the case where the target 2 as the detection object is made of a material with high electrical conductivity is described, but it is not limited to this case. For example, the detection object may be made of a magnetic material with high magnetic permeability. In this case, the magnetic flux is concentrated in the detection object and the position of the detection object relative to the substrate 3 can be detected because the magnetic flux density in the portion of the substrate 3 facing the detection object is higher than in other portions.

The moving member to be detected in position by the stroke sensor 1 is not limited to the rack shafts 13, 13A, 13B of the steering device 10, but may be an automotive or non-automotive shaft. The shape of the moving member is also not limited to a cylindrical shape, but may be a long plate shape, for example.

1. A position detection device for detecting a position of a moving member moving forward and backward in a predetermined moving direction, comprising:
a detection object attached to the moving member;
a substrate provided with an excitation coil being positioned to face the moving member and parallel to the moving direction of the moving member for generating a magnetic field in an area including the detection object, and a detection coil being interlinked with a magnetic flux of the magnetic field;
a power supply unit for supplying an alternating current to the excitation coil;
a calculation unit that calculates the position of the moving member based on an output voltage of the detection coil; and
a spacing fluctuation suppression structure that suppresses fluctuations in a spacing between a facing surface facing the detection object and the detection object in the substrate.

2. The position detection device, according to claim 1, wherein the spacing fluctuation suppression structure is a structure in which the facing surface of the substrate faces the detection object circumferentially around a central axis of the moving member.

3. The position detection device, according to claim 2, wherein the moving member is a rod-shaped shaft, and wherein the detection object is provided protruding from an outer peripheral surface of the shaft.

4. The position detection device, according to claim 3, wherein the detection object comprises two detection objects provided on the shaft so as to sandwich the substrate in a thickness direction.

5. The position detection device, according to claim 2, wherein a slit-shaped recess is provided in the moving member along the moving direction, and a portion of the substrate in which the excitation coil and the detection coil are formed is accommodated in the recess, and wherein a facing surface of the recess facing the substrate protrudes toward the substrate in a part of the moving direction, and the protruded portion is formed as the detection object.

6. The position detection device, according to claim 1, wherein the spacing fluctuation suppression structure is a structure that applies a force to the detection object, which is a separate body from the moving member, in a normal direction of the substrate.

7. The position detection device, according to claim 1, wherein the detection coil comprises two detection coils provided on the substrate, and phases of the voltages induced in the respective two detection coils while the moving member moves from one moving end to the other moving end are different from each other.

8. The position detection device, according to claim 1, wherein the moving member is a rack shaft of a steering device of a vehicle.
